(19) United States
(12) Patent Application Publication
(10) Pub. No.: US 2025/0101609 A1
(43) Pub. Date: Mar. 27, 2025

(54) MEMBRANE ELECTRODE ASSEMBLY

(71) Applicant: KS IPR UG (HAFTUNGSBESCHRÄNKT), Würselen (DE)

(72) Inventors: Martin KONRAD, Gosheim (DE); Stephan KÖHNE, Aachen (DE)

(21) Appl. No.: 18/728,331

(22) PCT Filed: Jan. 17, 2023
(86) PCT No.: PCT/EP2023/050924

§ 371 Date: Jul. 11, 2024

(30) Foreign Application Priority Data
Jan. 17, 2022 (DE) 10 2022 000 153.5

(51) Int. Cl. C25B 9/23; C25B 1/042; C25B 9/09; C25B 9/77; C25B 11/042; C25B 13/07; H01M 4/90; H01M 8/14; H01M 8/244

(52) U.S. Cl. CPC C25B 9/23; C25B 1/042; C25B 9/09; C25B 9/77; C25B 11/042; C25B 13/07; H01M 4/9025; H01M 8/145; H01M 8/244; H01M 2008/147

(57) ABSTRACT

The invention relates to a method, an electrolyte membrane, and a corresponding electrolysis cell or an electrolysis stack for producing hydrogen and oxygen from water vapor using electric energy and/or a corresponding fuel cell or a fuel cell stack in order to produce electric energy using hydrogen and oxygen by means of a redox reaction of lithiated iron oxide iron which is dissolved in a liquid alkali carbonate salt. The membrane for splitting water vapor into hydrogen and oxygen consists, in the embodiment according to the invention, of a novel lithiated iron oxide electrolyte which is dissolved in a liquid alkali carbonate salt mixture, generally also referred to as a carbonate melt, which includes lithium carbonate among others. The electrolyte and the liquid carbonate salt are bonded in a heat-resistant non-conductive matrix, for example consisting of lithium aluminate LiAlO₂ and/or another heat-resistant material with a capillary effect.

### FIELD OF THE INVENTION

The present invention relates to a membrane electrode assembly (MEA), which can be used for both preparing hydrogen and oxygen from steam using electric power, and preparing electric power using hydrogen and oxygen, and to the corresponding processes.

### BACKGROUND OF THE INVENTION

Hydrogen and the production of hydrogen from water using electric power is considered a key technology for the energy revolution. Thus, for example, hydrogen can be used as a storage for renewable energies.

An energy-efficient production of hydrogen offers a multitude of possibilities for eliminating hydrocarbon-based processes. Conversely, the reaction of hydrogen with oxygen may be used for producing (electric) power, where the challenge is to control the reaction.

The electrochemical cleavage of water into hydrogen and oxygen is well known and is described, for example, in US 2021/0313606 A1. However, this often requires high temperatures. The high temperatures are to be avoided from an energetic point of view, since all the material flows need to be heated and cooled, which means a high expenditure in equipment, and in addition, reduces energy efficiency. In addition, the process operates in a liquid phase. However, the solubility of water (steam) in a liquid is low. In addition, hydrogen and oxygen are in a gaseous state, which is a safety risk, especially at the high temperatures described.

In addition, separation of hydrogen and oxygen in a liquid is difficult, so that such separation has to be effected in a subsequent operation.

In molten carbonate fuel cells reforming of methane with water yields CO and hydrogen. The CO is then converted with water to CO₂ and hydrogen. Thus, in the overall process, methane is oxidized to carbon dioxide and water at temperatures of from 580° C. to 675° C.

Therefore, there is a need for improved processes that work in an environmentally-friendly and more efficient way. In addition, the process should be safe and not represent a risk for humans. CO₂ is not to be formed in the process if possible, whereby a further material cycle becomes unnecessary.

### BRIEF DESCRIPTION OF THE DRAWINGS

The present invention is illustrated and described herein with reference to the various drawings, in which like reference numbers denote like method steps and/or system components, respectively, and in which:

FIG. 1 is a schematic diagram illustrating electrolyte membrane according to the invention and related cell/stack for producing hydrogen and oxygen without the need for a CO₂ cycle and/or provision, which operates in accordance with the electrolysis cell process according to the invention; and

FIG. 2 is an illustration of the results of the Example where the current/voltage curve was measured at different voltages and effected at various temperatures, illustrating a significant drop of current density at temperatures of 350° C. and 300° C.

### DETAILED DESCRIPTION OF THE INVENTION

Surprisingly, it has been found that it is possible, using a specific membrane, to cleave water without a catalyst to obtain hydrogen even at lower temperatures from about 400° C. In this process, hydrogen and oxygen are obtained in separate product streams. In a first embodiment, therefore, the object of the present invention is achieved by a membrane electrode assembly that comprises at least one cathode, at least one anode, and an electrolyte, wherein said electrolyte has a three-dimensional spatial expansion, and said cathode is connected with the electrolyte at one surface, and said anode is connected with the electrolyte at the opposite surface, wherein said electrolyte comprises lithiated iron oxide (LiFeOₓ) and at least one carbonate.

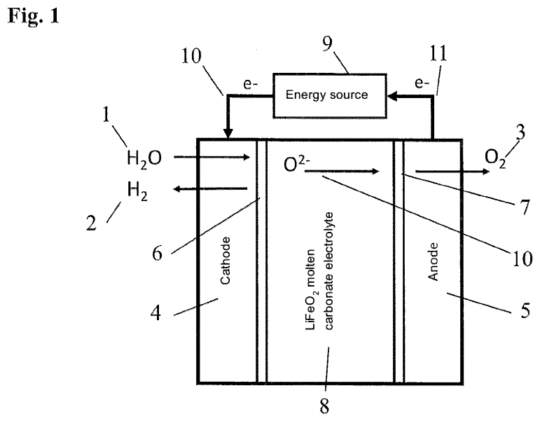

Surprisingly, it has been found that it is possible, using such a membrane in a corresponding membrane electrode assembly (MEA), to recover hydrogen and oxygen from steam using electric power supply. However, it is also possible to generate electric power in a reverse reaction by supplying hydrogen and oxygen. The MEA according to the invention for the first time enables the production of oxygen and hydrogen in separate product streams by a redox reaction. The reaction takes place at the surface of the membrane, and the membrane serves for ion transport. The membrane separates 2 compartments. In these compartments, hydrogen and oxygen are formed separately. At the same time, water or steam need not be introduced into the membrane or electrolyte, since the reaction takes place at the surface. FIG. 1 shows this schematically.

In a further embodiment, the object of the present invention is achieved by a process for producing hydrogen and oxygen, which is characterized in that
in a first step, steam is contacted with the electrolyte according to the invention,
applying a voltage causes the steam to react with the electrolyte, whereby said lithiated iron oxide is oxidized, and hydrogen is formed in the area of the cathode,
said lithiated iron oxide is reduced in the area of the anode to form oxygen.

In a further embodiment, the object of the present invention is achieved by an electrolysis cell or fuel cell comprising said MEA as described above for performing the process as described above. In a still further embodiment, the object of the present invention is achieved by a stack of electrolysis cells or fuel cells, comprising two, three or more electrolysis cells or fuel cells as described above.

Such an electrolysis cell or fuel cell is a cell, i.e., a closed space in which the MEA according to the invention separates two zones from one another, so that there is no exchange of material between these zones. A stack is a combination of two, three or more cells.

These embodiments are described in more detail hereinafter. If features are explained with respect to one embodiment, this also applies to all other embodiments, mutatis mutandis, if applicable. All features may be combined in any way desired.

Thus, a membrane within the meaning of the present invention is a three-dimensional body that comprises or consists of an electrolyte. Therefore, said membrane has at least two surfaces that are opposed to each other. Now, an electrode serving as the anode is attached to a first surface. There is also an electrode at a second, opposing surface of the membrane, which serves as a cathode. The function of said cathode or anode relates to the cleavage of water into hydrogen and oxygen, which is not supposed to mean, however, that the electrodes are not capable of being employed in the back reaction (generation of electric power from hydrogen and oxygen).

According to the invention, the electrolyte may be solid or liquid. To date, it has been considered that a solid structure of the electrolyte is not possible. However, it could be shown that a reaction takes place even at a solid electrolyte, which enables the MEA according to the invention to be used even at temperatures of below 300° C. in principle. Preferably, the electrolyte is liquid, since a more effective reaction occurs at higher temperatures. If the electrolyte is solid, the membrane can consist of the electrolyte. If the electrolyte is liquid, the membrane further comprises a support structure to keep the electrolyte in the desired position.

According to the invention, the membrane has oxygen ion conductibility in both the solid and the liquid states. For example, this enables the membrane to be operated already at lower temperatures above 100° C. In doing so, for example, a higher voltage (higher than the thermoneutral voltage) can be applied, which results in more thermal design power to heat up the cell through the membrane itself to the preferred temperature of at least 350° C. or more, especially at least 400° C. This makes cell heating in operation unnecessary. Once a desired operating temperature has been reached, the voltage can be lowered, in order to enable operation in a constant temperature range.

The thermoneutral voltage in a fuel cell is the voltage that would occur if the entire reaction enthalpy was converted to electric energy. Accordingly, in an electrolysis cell, it is the voltage at which the energy of the voltage completely flows into the reaction enthalpy, i.e., water is cleaved into hydrogen and oxygen with virtually no losses. At lower voltages, the reaction becomes less effective. At higher voltages, heat is formed, which is an energy loss. However, as described above, such heat can be utilized to control the temperature of the electrolyte without requiring additional heating.

An effective electron transport is possible, in particular, at temperatures of 350° C. or more. Therefore, the MEA according to the invention is operated, in particular, at temperatures of 300° C. or more, especially at 350° C. or more, preferably at 390° C. or more. At the same time, the MEA according to the invention enables effective operation even at temperatures of below 800° C., especially below 750° C., preferably below 650° C. This allows for safe working.

According to the invention, the membrane has such a design that it is not electrically conductive. Further, according to the invention, it has such a design that it can separate an anode compartment from a cathode compartment in an electrolysis or fuel cell, so that a short circuit does not occur. In addition, oxygen and hydrogen can be generated and discharged separately thereby. Thus, there are two separate mass flows, which ensures that hydrogen and oxygen do not react with one another in an uncontrolled way. In addition, these can be well collected and used separately from one another. Further, the MEA according to the invention enables steam to come into contact with the surface of the membrane and thus with the electrolyte. Thus, the steam need not be dissolved in the electrolyte, and the reaction (cleavage of steam into hydrogen and oxygen) takes place in a cell rather than in the electrolyte itself.

According to the invention, the membrane comprises at least one carbonate, and lithiated iron oxide, which are in the form of a uniform melt or of a uniform solid. The lithiated iron oxide may be melted first, and a carbonate dissolved therein, or a melt of a carbonate is prepared at first, in which the lithiated iron oxide is then dissolved. According to the invention, it is also possible that the carbonate and lithiated iron oxide are mixed at first, and subsequently melted together.

According to the invention, the electrolyte comprises at least one carbonate, especially a carbonate of an alkali metal or alkaline earth metal. Mixtures of two, three or more carbonates may also be used according to the invention. Mixtures of carbonates are particularly preferred, because they can form a eutectic having particularly low melting temperatures.

In a further embodiment, the present invention relates to a process for producing hydrogen and oxygen (electrolysis), which is characterized in that
in a first step, steam is contacted with the electrolyte according to the invention,
applying a voltage causes the steam to react with the electrolyte, whereby said lithiated iron oxide is oxidized, and hydrogen is formed in the area of the cathode,
said lithiated iron oxide is reduced in the area of the anode to form oxygen.

In a still further embodiment, the present invention relates to a process for generating electric power from hydrogen and oxygen (fuel cell), characterized in that
oxygen is contacted with the electrode in the area of the cathode, reacting with iron and Li₂O to LiFeO₂ while taking up electrons,
in a further step, hydrogen reacts with LiFeO₂ at the anode to form steam (H₂O), iron and Li₂O while emitting electrons,
   wherein electrons flowing from the anode to the cathode.

Thus, the basic idea of the process according to the invention resides in the reaction of gaseous water (steam) with iron to form iron oxide. The latter is in a dissolved state in the electrolyte, in which lithium ions are also present, so that a lithium iron oxide is formed. This process is also shown schematically in FIG. 1.

It is particularly advantageous for the lithium iron oxide to be dissolved in a eutectic, since such a mixture of carbonates has a substantially lower melting temperature as compared to the pure carbonate materials. Thus, in particular, the operation may be at temperatures from 350° C., especially from 390° C., preferably from 400° C.

Thus, the invention relates to a process and a membrane in an MEA and to a related electrolysis cell or electrolysis stack for producing hydrogen and oxygen from steam using electric power, and/or a related fuel cell or fuel cell stack for generating electric power using hydrogen and oxygen and using a redox reaction of a lithiated iron oxide/iron mixture dissolved in an alkali carbonate.

The membrane according to the invention in the MEA for cleaving steam into hydrogen and oxygen comprises a novel lithiated iron oxide dissolved in a mixture of alkali carbonate salts in the embodiment according to the invention. The dissolving of the lithiated iron oxide in said mixture of alkali carbonate salts results in an electrically non-conductive electrolyte. Lithiated iron oxide alone is electrically conductive and therefore cannot be used as the electrolyte, since electric conductivity would lead to a short circuit within the cell. The dissolving of the lithiated iron oxide, for example, LiFeO₂, in said eutectic/solution consisting of carbonate salts causes the lithiated iron oxide to become liquefied earlier than it would have in pure form, and therefore, the electrolysis cell and fuel cell can be operated at lower temperatures. In addition, the membrane that consists of a mixture of carbonate salts and LiFeO₂ can be used as an electrolyte even in the solid state. Said iron oxide may be dissolved in any form of appearance, for example, as FeO as the simplest form.

In order to stabilize the novel electrolyte in the electrolysis cell and/or fuel cell according to the invention between at least one anode side and at least one cathode side, the electrolyte can be preferably bonded within a heat-resistant non-conductive matrix, for example, of lithium aluminate, for example, LiAlO₂, and/or another heat-resistant material, especially with a capillary effect. In a preferred embodiment, said novel liquid electrolyte, which comprises the liquid carbonate salt and lithiated iron oxide dissolved therein is retained in the matrix by the capillary effect, so that this unit forms a membrane that can be realized with an anode side and cathode side and a manifold structure for supplying and discharging the feed materials steam, hydrogen and oxygen for the electrochemical reaction, without dispelling the electrolyte. The MEA according to the invention can be employed both in the electrolysis cell and in a fuel cell.

The most important types of electrolyte are known from the literature, and according to the recent state of the art, these include predominantly alkali, molten carbonate, phosphoric acid, proton-exchange membrane (PEM), and solid oxides. The first three are liquid electrolytes; the latter two are solids. In contrast, the novel membrane can be operated in both the liquid and solid states.

In the MEA and/or electrolysis cell and/or electrolysis stack and/or fuel cell and/or fuel cell stack according to the invention, molten alkali carbonates are preferably employed as the liquid. In such a molten alkali carbonate, for example, lithium carbonate Li₂CO₃, potassium carbonate K₂CO₃ and/or sodium carbonate Na₂CO₃ and/or mixtures thereof are employed. Lithiated iron oxide is dissolved in such a molten carbonate.

In the approach according to the invention, the redox reaction of iron and lithium iron oxide is combined with the molten carbonate, since the lithiated iron oxides can be dissolved in the molten carbonate, and thus the mixture becomes liquid at lower temperatures as compared to lithiated iron oxides alone, such as LiFeO₂ in a pure form. In addition, LiFeO₂ in a pure form is electrically conductive and thus not suitable as a membrane material. By means of the lithium oxide, iron oxide can be dissolved in the molten carbonate independently of its actual form (exact stoichiometric composition), and forms a lithiated iron oxide electrolyte together with the lithium oxide in a molten carbonate. Because of this dissolving iron oxide in the presence of lithium oxide in the molten carbonate at temperatures of around 400° C., the iron redox reaction also takes place already at temperatures of less than 400° C.

The cathode reaction, in which the steam reacts to hydrogen and iron oxide, is similar to the long known “steam-iron reaction”, which is at equilibrium at about 550° C. Therefore, no additional catalyst is required on the cathode side in addition to the supplied electric power. As soon as sufficient voltage is applied to the electrolysis membrane, the reactions at the anode and cathode are initiated. On the anode side, oxygen is produced from the lithiated iron oxide with emission of electrons, in which the iron oxide is converted to iron. Said iron oxide may be in the melt and in the individual reactions in its different forms of appearance, i.e., iron(II) oxide (FeO), iron(II,III) oxide (Fe₃O₄), and/or iron(III) oxide (Fe₂O₃).

In the case of being used for electrolysis, the iron in the molten carbonate in the electrolyte membrane and in the related cell/stack is in turn contacted with the steam supplied at the cathode to form iron oxide and hydrogen in turn at the cathode with accepting of electrons. The electrons and the necessary voltage are provided through a usual external electric circuit.

The iron oxide in turn together with the lithium compounds is dissolved to form lithiated iron oxide, which is then in turn decomposed by the provided electrons and the necessary voltage.

The solution according to the invention is advantageous in that, in contrast to conventional molten carbonate systems, whether as fuel cells and/or as an electrolysis application, no CO₂ cycle is required to operate the electrochemical reactions, and thus the complicated separation and recirculation of CO₂ can be omitted.

In addition, the process of the electrolyte membrane and related cell/stack according to the invention can be operated even at lower temperatures from about 400° C. All in all, with this process, because of the operating temperatures, which are lower than those of comparable molten carbonate electrolysis cells and the omission of CO₂ provision and/or cycling, hydrogen can be produced in a substantially more energy-efficient way as compared to the currently known systems, and material issues at higher temperatures are avoided.

Molten carbonates include alkali carbonates, such as lithium carbonate, sodium carbonate, potassium carbonates, and mixtures of two or more of the above alkali carbonates. Mixtures of alkali carbonates can be advantageous because of lower melting points. For example, Li_{0.7}Na_{0.93}CO₃ has a melting point of 499° C., and Li_{0.85}Na_{0.61}K_{0.54}CO₃ has a melting point of 393° C. As compared with melting points of the individual alkali carbonates, such as Li₂CO₃ with 723° C., Na₂CO₃ with 851° C., and/or K₂CO₃ with 891° C., purposeful mixing yields ideal operating temperatures, in which the mixture is liquid and can take up iron oxide.

The reaction of iron oxide with steam is particularly advantageous in the temperature range of below 570° C. The electrolyte membrane according to the invention and the related cell/stack is characterized in that it consists of at least one cathode, anode and matrix, especially with a nanoporous non-conductive ceramic structure, for example, of lithium aluminate LiAlO₂, which serves for fixing the molten electrolyte, which comprises at least one carbonate salt and lithiated iron oxide, and has a capillary effect, so that there is no leaking, if possible, of the electrolyte at the anode side and cathode side, and the two sides are separated by the membrane according to the invention, also electrically. If needed, different catalysts may be employed for the respective reaction on said anode and/or cathode side. According to the invention, these are not necessary, so that no catalysts are used in a preferred embodiment.

In an embodiment according to the invention, the anode includes a porous metallic foam structure, for example, a nickel or zinc foam structure, and especially consists of such a structure.

In an embodiment according to the invention, the cathode includes a porous structure made of a metal or a mixture of 2 or more metals, especially it includes a porous nickel oxide/lithium mixture, more preferably it consists thereof.

In the interface between the membrane according to the invention and the cathode, hydrogen and iron oxide FeOₓ is formed from steam and iron. The iron oxide formed dissolves in the molten carbonate in turn to form lithiated iron oxide in the membrane, which is in turn converted to iron at the anode in the interface between the membrane and the anode, producing oxygen molecules and emitting electrons.

The electrolyte membrane according to the invention and the related cell/stack may also be utilized in a reverse operating mode as a fuel cell for the controlled generation of electric power from hydrogen and oxygen.

Further features, advantages and details of the invention are explained in more detail below with reference to the drawing, which schematically contains an embodiment variant. FIG. 1 shows the basic set-up exemplified by an electrolyte membrane according to the invention and related cell/stack for producing hydrogen and oxygen without the need for a CO₂ cycle and/or provision, which operates in accordance with the electrolysis cell process according to the invention.

The electrolyte membrane according to the invention and related cell/stack consists of at least one cathode 4 and at least one anode 5 and at least one electrolyte membrane 8, which embeds the novel liquid electrolyte in a stable matrix, serving as a membrane and separating the two sides, i.e., the anode and cathode sides. Water and/or steam is supplied to the cathode side 4 through a steam supply line. A voltage is applied to the system through an external energy source 9.

The lithiated iron oxide decomposes on the anode side 5 with emission of electrons into oxygen, iron and lithium oxide. The electrons are sent to the cathode side 5 through a power line 11 through the power source 9 and the electron supply line 10. In the molten electrolyte there, the iron reacts with the supplied water/steam and the electrodes to lithiated iron oxide again, producing hydrogen.

The invention is not limited to the embodiment variant represented in FIG. 1. The electrolyte membrane according to the invention and the related electrolyzer cell/electrolyzer stack or fuel cell/fuel cell stack can be built and/or connected from several compartments and/or arrangements and/or geometric shapes, to form a stack, for example. In particular, the electrolyte membrane according to the invention and the related cell/stack can also be operated as a fuel cell by supplying hydrogen and oxygen/air to the respective side.

In the following Example, the present invention is further explained in a non-limiting way.

### Example

A molten alkali carbonate was prepared. Thus, lithium carbonate Li₂CO₃, potassium carbonate K₂CO₃ and sodium carbonate Na₂CO₃ were mixed together and melted, so that a molten carbonate Li_{0.85}Na_{0.61}K_{0.54}CO₃ was obtained. LiOH and Fe₂O₃ were added to this molten carbonate to obtain an electrolyte according to the invention. The latter was introduced into a membrane (a ceramic matrix was used). The membrane was connected with a cathode and an anode.

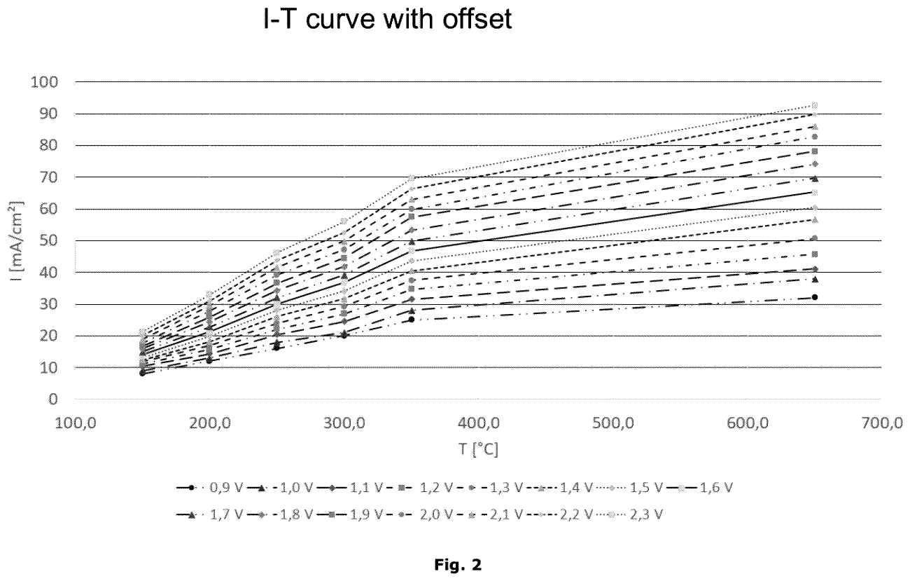

This MEA was contacted with steam in a cell, and the current/voltage curve was measured at different voltages. The measurements were respectively effected at temperatures of 150° C., 200° C., 250° C., 300° C., 350° C., and 650° C. The results are shown in FIG. 2.

The curve shows a significant drop of current density at temperatures of 350° C. and 300° C. In this region, the electrolyte becomes solid. Since a current density could nevertheless be measured, this shows that the electrolyte may also be employed in its solid state, but a more effective water cleavage or power generation is possible in a liquid form. Therefore, the process according to the invention is preferably performed at temperatures of from 350° C. to 700° C., especially from 400° C. to 650° C., preferably from 450° C. and 600° C. At higher temperatures, there is an additional energy demand without the reaction becoming significantly more effective.

For an economically efficient reaction and operation, the voltage to be applied and process temperature employed are to be adjusted accordingly, which can be set depending on the conditions and need.

### LIST OF REFERENCE SYMBOLS

1 . . . Water/steam supply
2 . . . Steam discharge
3 . . . Oxygen discharge
4 . . . Cathode
5 . . . Anode
6 . . . Reaction zone cathode side
7 . . . Reaction zone anode side
8 . . . Electrolyte membrane with a stable matrix, separation of the two reaction sides
9 . . . Energy source
10 . . . Electron supply
11 . . . Electron discharge

1. A membrane electrode assembly (MEA) comprising at least one cathode, at least one anode, and an electrolyte, wherein said electrolyte has a three-dimensional spatial expansion, and said cathode is connected with the electrolyte at one surface, and said anode is connected with the electrolyte at the opposite surface, wherein said electrolyte comprises lithiated iron oxide (LiFeOₓ) and at least one carbonate.

2. The membrane electrode assembly according to claim 1, wherein said electrolyte is not electrically conductive.

3. The membrane electrode assembly according to claim 1, wherein the electrolyte is a membrane for producing hydrogen and oxygen from steam using a supply of electric power, and/or a membrane for generating electric power by supplying hydrogen and oxygen.

4. The membrane electrode assembly of claim 1, wherein the electrolyte is embedded in a solid support matrix, wherein said solid support matrix has in particular a ceramic non-conductive oxide structure.

5. The membrane electrode assembly according to claim 4, wherein said solid support matrix comprises a porous structure of lithium aluminate.

6. The membrane electrode assembly of claim 1, wherein the cathode comprises nickel oxide.

7. The membrane electrode assembly of claim 1, wherein an electrolysis cell or fuel cell comprises the membrane electrode assembly.

8. The membrane electrode assembly of claim 7, wherein an electrolysis stack or fuel cell stack, comprises two or more of the electrolysis cells or fuel cells.

9. A process for producing hydrogen and oxygen from steam, comprising:
providing a membrane electrode assembly (MEA) comprising at least one cathode, at least one anode, and an electrolyte, wherein said electrolyte has a three-dimensional spatial expansion, and said cathode is connected with the electrolyte at one surface, and said anode is connected with the electrolyte at the opposite surface, wherein said electrolyte comprises lithiated iron oxide (LiFeOₓ) and at least one carbonate;
contacting the steam with the electrolyte;
applying a voltage causing the steam to react with the electrolyte, whereby said lithiated iron oxide (LiFeOₓ) is oxidized, and hydrogen is formed in the area of the cathode; and
reducing said lithiated iron oxide (LiFeOₓ) in the area of the anode to form oxygen.

10. A process for generating electric power from hydrogen and oxygen, comprising:
providing a membrane electrode assembly (MEA) comprising at least one cathode, at least one anode, and an electrolyte, wherein said electrolyte has a three-dimensional spatial expansion, and said cathode is connected with the electrolyte at one surface, and said anode is connected with the electrolyte at the opposite surface, wherein said electrolyte comprises lithiated iron oxide (LiFeOₓ) and at least one carbonate;
contacting oxygen with the electrode in the area of the cathode, reacting with iron and Li₂O to LiFeO₂ while taking up electrons; and
reacting hydrogen with LiFeO₂ at the anode to form steam (H₂O), iron and Li₂O while emitting electrons
wherein electrons flow from the anode to the cathode.

11. The process according to claim 9, wherein said process is performed without the presence of a catalyst.

12. The process according to claim 10, wherein said process works both in the liquid and solid states of the membranes.

13. The process according to claim 10, wherein said process is performed in a solid state from a temperature of 100° C. or more.

14. The process according to claim 10, wherein said process is performed in a liquid state from a temperature of 400° C. or more.

15. The process according to claim 9, wherein said process is performed without the presence of a catalyst.

16. The process according to claim 9, wherein said process works both in the liquid and solid states of the membranes.

17. The process according to claim 9, wherein said process is performed in a solid state from a temperature of 100° C. or more.

18. The process according to claim 9, wherein said process is performed in a liquid state from a temperature of 400° C. or more.
